(19) United States
(12) Patent Application Publication
(10) Pub. No.: US 2005/0008563 A1
(43) Pub. Date: Jan. 13, 2005

(54) Powder as a positive active material, battery, and method for manufacturing a battery

(75) Inventor: Yoshinori Naruoka, Kyoto-shi (JP)

Correspondence Address: SUGHRUE MION, PLLC, 2100 PENNSYLVANIA AVENUE, N.W., SUITE 800, WASHINGTON, DC, 20037, US

(73) Assignee: JAPAN STORAGE BATTERY CO., LTD.

(21) Appl. No.: 10/838,322

(22) Filed: May 5, 2004

(30) Foreign Application Priority Data
May 6, 2003 (JP) P. 2003-128235

(51) Int. Cl. C01G 45/12; B22F 1/00; C22C 32/00; H01M 6/00; H01M 4/58; H01M 10/00

(52) U.S. Cl. 423/593.1; 429/231.95; 419/19; 423/599; 423/594.3; 423/594.4; 423/594.5; 423/594.6; 423/594.15

(57) ABSTRACT

A powder which has a hexagonal crystal structure and is used as a positive active material for a non-aqueous electrolyte rechargeable battery, and wherein the nominal composition of the positive active material is represented by LiₐNi_{b}Co_{c}Mn_{d}AlₑO₂, the values of a, b, c, d, and e in the nominal equation fall within the ranges of 0.05≦a≦1.20, 0.25≦b≦0.93, 0.05≦c≦0.35, 0.01≦d≦0.35, 0.01≦e≦0.15, and 0.9≦b+c+d+e≦1.1, respectively, and the tap density of the powder lies 1.6 to 3.0 g/ml.

### FIELD OF THE INVENTION

The present invention relates to a powder as a positive active material for a non-aqueous electrolyte rechargeable battery, a non-aqueous electrolyte rechargeable battery having the powder as a positive active material, and a method for manufacturing the non-aqueous electrolyte rechargeable battery using the powder as a positive active material.

### BACKGROUND OF THE INVENTION

Recently, portable electronic devices have been remarkably miniaturized and reduced in weight, and accordingly the demands for rechargeable batteries, as a power source, of smaller size and lighter weight are increasing. In order to fulfill such demands, various rechargeable batteries have been developed. Among them, a lithium-ion battery where the compound lithium cobalt oxide with a layer structure is used as a positive active material is attracting attention and widely used. The reason of being in wide use is that a lithium-ion battery has a high operating voltage and a high energy density which are suitable for use in the above mentioned application.

However, since cobalt is not an abundant resource, it cost much more than other materials. Therefore, as a positive active material alternative to the compound lithium cobalt oxide, lithium manganese oxide or lithium nickel oxide has been proposed.

Regarding these alternatives, lithium manganese oxide has problems in that the theoretical capacity is low and a reduction in capacity due to charge and discharge cycle is large. Lithium nickel oxide, on the other hand, has the highest theoretical capacity but the charge and discharge cycle characteristic is not satisfactory.

For lithium nickel oxide where the molar ratio of lithium does not represent a stoichiometry ratio completely, it is very likely to form an incomplete hexagonal crystal structure where Ni element is intercalated in Li layer site. As a result, due to the repeated expansion and contraction of composite oxide particles during charge and discharge, the particles are apt to be broken easily and accordingly lose contact with other particles or conductive agents. Therefore, this may result in a reduction in a charge and discharge cycle characteristic.

In Provisional Publication No.266876 of 2001 in Japanese Published Unexamined Patent Application, the use of positive active materials, wherein the general equation is represented by LiₓNi_{y}Co_{z}Al_{(1-y-z)}O₂ (where 0.05≦x≦1.10, 0.7≦y≦0.9, 0.05≦z≦0.18, and 0.85≦y+z≦0.98), a specific surface area is less than 0.7 m²/g, and a tap density is larger than 2.3 g/ml, has been proposed. The aim of this prior art literature is to provide a non-aqueous electrolyte battery which has a high capacity and an excellent storage characteristic in a high-temperature environment.

### BRIEF SUMMARY OF THE INVENTION

The first claim in the present invention is characterized in a powder which has a hexagonal crystal structure and is used as a positive active material for a non-aqueous electrolyte rechargeable battery, and wherein the nominal composition of said positive active material is represented by LiₐNi_{b}Co_{c}Mn_{d}AlₑO₂; the values of a, b, c, d, and e in said nominal equation fall within the ranges of 0.05≦a≦1.20, 0.25≦b≦0.93, 0.05≦c≦0.35, 0.01≦d≦0.35, 0.01≦e≦0.15, and 0.9≦b+c+d+e≦1.1, respectively; and the tap density of said powder lies 1.6 to 3.0 g/ml.

In a non-aqueous electrolyte rechargeable battery which was manufactured using the powder according to the first claim as a positive material, a reduction in discharge capacity due to repeated charge and discharge can be prevented, and a high capacity can be obtained during discharge at either high or low rate.

Regarding the claims in this application, the expression that the nominal composition of the positive active material is represented by “LiₐNi_{b}Co_{c}Mn_{d}AlₑO₂” should not be construed as meaning that no elements other than Li, Ni, Co, Mn, Al, and O are included. Even if other elements than those specified are included, if the ratios of Li, Ni, Co, Mn, and Al elements to oxygen element fall within the respective ranges previously specified in the nominal composition, a composition is naturally considered equivalent to LiₐNi_{b}Co_{c}Mn_{d}AlₑO₂ described in the claims in this application.

### DESCRIPTION OF PREFERRED EMBODIMENTS

In the present invention, a composite oxide containing lithium, nickel, cobalt, manganese, and aluminium is used as a positive active material for a non-aqueous electrolyte rechargeable battery. By identifying the composition ratio and the property value of the composite oxide, a capacity density of larger than 150 mAh/g and an excellent cycle characteristic, which are approximately equivalent to those of the compound lithium cobalt oxide, can be obtained, and also the safety of the battery improves greatly. Furthermore, cobalt content of the composite oxide is less than that of the compound lithium cobalt oxide; therefore, it is possible to provide a non-aqueous electrolyte rechargeable battery at lower cost.

Thus, in the present invention, a composite oxide powder which has a hexagonal crystal structure, and wherein the nominal composition is represented by LiₐNi_{b}Co_{c}Mn_{d}AlₑO₂ (where 0.05≦a≦1.20, 0.25≦b≦0.93, 0.05≦c≦0.35, 0.01≦d≦0.35, 0.01≦e≦0.15, and 0.9≦b+c+d+e≦1.1, respectively) and a tap density lies 1.6 to 3.0 g/ml, is used as a positive active material for a non-aqueous electrolyte rechargeable battery.

In the foregoing nominal composition, a c-value of less than 0.05 causes the crystal structure of a positive active material to be unstable, while a c-value of larger than 0.35 leads to an increase in the cost of a positive active material. In case a d-value is less than 0.01 and an e-value is less than 0.01, the thermal stability of a positive active material cannot be secured. In case a d-value is larger than 0.35 and an e-value is larger than 0.15, the capacity of a positive electrode becomes small.

In the present invention, with a tap density of composite oxide powders lying in the range of 1.6 to 3.0 g/ml, a reduction in discharge capacity due to repeated charge and discharge can be prevented and, at the same time, a high capacity can be obtained at high rate discharge.

The reason can be explained as follows. In case a tap density is less than 1.6 g/ml, many holes are present in composite oxide particles. This can cause the particles to be broken easily during a charge and discharge cycle, lead to an immediate decrease in the number of contacts between the particles or between the particle and a conductive agent, and consequently the charge and discharge cycle characteristic is remarkably reduced. On the other hand, in case a tap density is larger than 3.0 g/ml, composite oxide particles become so dense that an electrolyte solution cannot penetrate sufficiently inside the particles. As a result, electrode reactions are blocked; in other words, concentration polarization of lithium ion during discharge becomes large and this results in deterioration of a high rate discharge characteristic.

### EMBODIMENTS

Hereinafter, embodiments of the present invention will be described together with comparative examples.

### Embodiment 1

A mixed carbonate having the nominal composition of Ni_{0.58}Co_{0.17}Mn_{0.25}CO₃, which is the starting material of a positive active material, and 3 mol % of aluminium hydroxide and 108 mol % of lithium hydroxide, respectively, with respect to the mixed carbonate were mixed together. The mixture was subjected to a firing at 800° C. for 12 hours in an oxygen atmosphere. The obtained composite oxide was found to have the nominal composition of Ni_{0.56}Mn_{0.25}CO_{0.15}Al_{0.03}O₂, forming a hexagonal crystal structure. In addition, the tap density of powdered composite oxide was 1.6 g/ml.

87% above-prepared composite oxide powder, 5% acetylene black, and 8% poly(vinylidene fluoride), respectively, by weight were mixed together to prepare a positive electrode mixture. N-methyl-2-pyrrolidone was added to this positive electrode mixture so as to make it viscous. The obtained viscous substance was then filled in foamed aluminium with 90% porosity. Furthermore, this preparation was dried at 150° C. in a vacuum to completely evaporate the solvent or n-methyl-2-pyrrolidone, and then press-molded.

The press-molded positive electrode having an electrode area of 2.25 cm² and the counter and reference electrodes made of metal lithium were put into a cell case made of glass. Then the case was filled with a non-aqueous electrolyte solution which was prepared by dissolving 1 mol/l of LiClO₄ with the mixed solvent where the volume ratio of ethylene carbonate to diethyl carbonate was 1:1. This embodiment is-referred to as Test Cell A.

### Embodiment 2

In this embodiment of preparing a composite oxide powder as a positive active material, preparation procedures were identical to those of Embodiment 1, except that the mixture was subjected to a firing at 850° C. for 12 hours, and the tap density of powdered composite oxide was 1.9 g/ml. This embodiment is referred to as Test Cell B.

### Embodiment 3

In this embodiment of preparing a composite oxide powder as a positive active material, preparation procedures were identical to those of Embodiment 1, except that the mixture was subjected to a firing at 900° C. for 12 hours, and the tap density of powdered composite oxide was 2.3 g/ml. This embodiment is referred to as Test Cell C.

### Embodiment 4

In this embodiment of preparing a composite oxide powder as a positive active material, preparation procedures were identical to those of Embodiment 1, except that the mixture was subjected to a firing at 950° C. for 12 hours, and the tap density of powdered composite oxide was 2.7 g/ml. This embodiment is referred to as Test Cell D.

### Embodiment 5

In this embodiment of preparing a composite oxide powder as a positive active material, preparation procedures were identical to those of Embodiment 1, except that the mixture was subjected to a firing at 1000° C. for 12 hours, and the tap density of powdered composite oxide was 3.0 g/ml. This embodiment is referred to as Test Cell E.

### Comparative Example 1

In this example of preparing a composite oxide powder as a positive active material, preparation procedures were identical to those of Embodiment 1, except that the mixture was subjected to a firing at 750° C. for 12 hours, and the tap density of powdered composite oxide was 1.5 g/ml. This example is referred to as Test Cell F.

### Comparative Example 2

In this example of preparing a composite oxide powder as a positive active material, preparation procedures were identical to those of Embodiment 1, except that the mixture was subjected to a firing at 1050° C. for 12 hours, and the tap density of powdered composite oxide was 3.1 g/ml. This example is referred to as Test Cell G.

Positive electrodes of Test Cells A to G in Embodiments 1 to 5 and Comparative Examples 1 and 2 were charged up to 4.3 V with respect to metal lithium at a constant current of 1.0 mA/cm². Subsequently, they were discharged down to 3.0 V with respect to metal lithium at constant currents of 1.0 mA/cm² and 10.0 mA/cm², and then discharge capacities per gram of positive active material were measured, respectively. In addition, supposing that a charge up to 4.3 V and a discharge down to 3.0 V, respectively, with respect to metal lithium at a constant current of 1.0 mA/cm² is considered one cycle, 50 charge and discharge cycles were performed to measure discharge capacity retention. Here, “discharge capacity retention” is defined as the ratio (%) of the discharge capacity at the 50th cycle to that of the 1st cycle. The obtained results are listed in Table 1.

TABLE 1

| | | Tap | | | Discharge |
|---|---|---|---|---|---|
| | Test | density | Discharge capacity (mAh/g) | | capacity |
| | Cell | g/ml | 1.0 mA/cm² | 10.0 mA/cm² | retention % |
| Comp. 1 | F | 1.5 | 161 | 127 | 78 |
| Embod. 1 | A | 1.6 | 161 | 125 | 91 |
| Embod. 2 | B | 1.9 | 162 | 127 | 94 |
| Embod. 3 | C | 2.3 | 160 | 120 | 96 |
| Embod. 4 | D | 2.7 | 160 | 112 | 98 |
| Embod. 5 | E | 3.0 | 160 | 110 | 98 |
| Comp. 2 | G | 3.1 | 162 | 98 | 95 |

As shown in Table 1, during discharge at a low current of 1.0 mA/cm², there was no significant difference in the relationship between tap densities and discharge capacities. However, when a high current of 10.0 mA/cm² was applied, discharge capacities decreased as tap densities increased; the lowest value was found in case of Test Cell G in Comparative Example 2. Capacity retentions after 50 cycles, on the other hand, showed higher values with an increase in tap densities.

Based on these findings, it is noted that in case composite oxide powders in Embodiments 1 to 5, whose tap densities lie in the range of 1.6 to 3.0 g/ml, are used as positive active materials, high-rate discharge performance and excellent cycle performance can be provided simultaneously.

### Comparative Example 3

In this example of preparing a composite oxide powder as a positive active material, preparation procedures were identical to those of Embodiment 1, except that the nominal composition was represented by LiNi_{0.63}Co_{0.04}Mn_{0.30}Al_{0.03}O₂ and the tap density of powdered composite oxide was 2.5 g/ml. This example is referred to as Test Cell H.

### Comparative Example 4

In this example of preparing a composite oxide powder as a positive active material, preparation procedures were identical to those of Embodiment 1, except that the nominal composition was represented by LiNi_{0.46}Co_{0.15}Mn_{0.36}Al_{0.30}O₂ and the tap density of powdered composite oxide was 1.9 g/ml. This example is referred to as Test Cell I.

### Comparative Example 5

In this example of preparing a composite oxide powder as a positive active material, preparation procedures were identical to those of Embodiment 1, except that the nominal composition was represented by LiNi_{0.49}Co_{0.15}Mn_{0.20}Al_{0.16}O₂ and the tap density of powdered composite oxide was 2.2 g/ml. This example is referred to as Test Cell J.

With Test Cells H to J in Comparative Examples 3 to 5, discharge capacities at 1.0 mA/cm² and 10.0 mA/cm², respectively, and discharge capacity retention after 50 charge and discharge cycles were measured, under the same condition as Embodiment 1. The obtained results are listed in Table 2.

TABLE 2

| | | Tap | | | Discharge |
|---|---|---|---|---|---|
| | Test | density | Discharge capacity (mAh/g) | | capacity |
| | Cell | g/ml | 1.0 mA/cm² | 10.0 mA/cm² | retention % |
| Comp. 3 | H | 2.5 | 165 | 130 | 67 |
| Comp. 4 | I | 1.9 | 140 | 110 | 92 |
| Comp. 5 | J | 2.2 | 136 | 104 | 91 |

As shown in Table 2, every tap density of composite oxide powders used as positive active materials in Comparative Examples 3 to 5 fell within the range of 1.6 to 3.0 g/ml. However, regarding Comparative Example 3, where the amount of cobalt added to the composite oxide was less than 0.05, its crystal structure tends to be unstable. In this regard, it was found that the discharge capacity retention resulted in a very small value and the charge and discharge cycle characteristic deteriorated. In addition, regarding Comparative Example 4, where the amount of manganese added to the composite oxide was larger than 0.35, and Comparative Example 5, where the amount of aluminium added to the composite oxide was larger than 0.15, it was found that discharge capacities at a low rate of 1.0 mA/cm² decreased. This indicates that only when the composition of positive active materials falls within the range specified in the present invention, both low-rate discharge performance and cycle performance can be achieved satisfactorily.

Such effects are not limited to the composition of positive active materials in the foregoing Embodiments 1 to 5 only. In a composite oxide used as a positive active material, when nickel content b falls within the range of 0.25≦b≦0.93, cobalt additive c of 0.05≦c≦0.35, manganese additive d of 0.01≦d≦0.35, and aluminium additive e of 0.01≦e≦0.15, it is possible to obtain the same effects as those of the above mentioned embodiments.

In fact, similar tests to Embodiments 1 to 5 were conducted using three positive active materials, whose compositions are represented by LiNi_{0.25}Co_{0.35}Mn_{0.25}Al_{0.15}O₂, LiNi_{0.25}Co_{0.25}Mn_{0.35}Al_{0.15}O₂, and LiNi_{0.93}Co_{0.05}Mn_{0.01}Al_{0.01}O₂, respectively. Consequently, the same results as those of Embodiments 1 to 5 were obtained.

### Embodiment 6

In this example of preparing a composite oxide powder as a positive active material, preparation procedures were identical to those of Embodiment 1, except that the nominal composition was represented by LiNi_{0.67}Co_{0.20}Mn_{0.10}Al_{0.03}O₂, the mixture was subjected to a firing at 650° C. for 12 hours, and the tap density of powdered composite oxide was 1.6 g/ml. This example is referred to as Test Cell K.

### Embodiment 7

In this example of preparing a composite oxide powder as a positive active material, preparation procedures were identical to those of Embodiment 6, except that the mixture was subjected to a firing at 700° C. for 12 hours, and the tap density of powdered composite oxide was 1.9 g/ml. This example is referred to as Test Cell L.

### Embodiment 8

In this example of preparing a composite oxide powder as a positive active material, preparation procedures were identical to those of Embodiment 6, except that the mixture was subjected to a firing at 750° C. for 12 hours, and the tap density of powdered composite oxide was 2.4 g/ml. This example is referred to as Test Cell M.

### Embodiment 9

In this example of preparing a composite oxide powder as a positive active material, preparation procedures were identical to those of Embodiment 6, except that the mixture was subjected to a firing at 800° C. for 12 hours, and the tap density of powdered composite oxide was 2.8 g/ml. This example is referred to as Test Cell N.

### Embodiment 10

In this example of preparing a composite oxide powder as a positive active material, preparation procedures were identical to those of Embodiment 6, except that the mixture was subjected to a firing at 850° C. for 12 hours, and the tap density of powdered composite oxide was 3.0 g/ml. This example is referred to as Test Cell O.

### Comparative Example 6

In this example of preparing a composite oxide powder as a positive active material, preparation procedures were identical to those of Embodiment 6, except that the mixture was subjected to a firing at 600° C. for 12 hours, and the tap density of powdered composite oxide was 1.4 g/ml. This example is referred to as Test Cell P.

### Comparative Example 7

In this example of preparing a composite oxide powder as a positive active material, preparation procedures were identical to those of Embodiment 6, except that the mixture was subjected to a firing at 900° C. for 12 hours, and the tap density of powdered composite oxide was 3.1 g/ml. This example is referred to as Test Cell Q.

With Test Cells K to Q in Embodiments 6 to 10 and Comparative Examples 6 and 7, discharge capacities at 1.0 mA/cm² and 10.0 mA/cm², respectively, and discharge capacity retention after 50 charge and discharge cycles were measured, under the same condition as Embodiment 1. The obtained results are listed in Table 3.

TABLE 3

| | | Tap | | | Discharge |
|---|---|---|---|---|---|
| | Test | density | Discharge capacity (mAh/g) | | capacity |
| | Cell | g/ml | 1.0 mA/cm² | 10.0 mA/cm² | retention % |
| Comp. 6 | P | 1.4 | 182 | 143 | 72 |
| Embod. 6 | K | 1.6 | 180 | 140 | 92 |
| Embod. 7 | L | 1.9 | 182 | 138 | 93 |
| Embod. 8 | M | 2.4 | 180 | 135 | 91 |
| Embod. 9 | N | 2.8 | 180 | 126 | 96 |
| Embod. | O | 3.0 | 181 | 124 | 95 |
| 10 | | | | | |
| Comp. 7 | Q | 3.1 | 181 | 107 | 93 |

As shown in Table 3, during discharge at a low current of 1.0 mA/cm², there was no significant difference in the relationship between tap densities and discharge capacities. However, when a high current of 10.0 mA/cm² was applied, discharge capacities decreased as tap densities increased; the lowest value was found in case of Test Cell Q in Comparative Example 7. Capacity retentions after 50 cycles, on the other hand, showed higher values with an increase in tap densities; the lowest value Was found in case of Test Cell P in Comparative Example 6.

Based on these findings, it is noted that in case composite oxide powders in Embodiments 6 to 10, where tap densities lie in the range of 1.6 to 3.0 g/ml and the nominal composition was represented by LiNi_{0.67}Co_{0.20}Mn_{0.10}Al_{0.30}O₂, are used as positive active materials, both high-rate discharge performance and cycle performance can be achieved satisfactorily.

### Embodiment 11

In this example of preparing a composite oxide powder as a positive active material, preparation procedures were identical to those of Embodiment 1, except that the nominal composition was represented by LiNi_{0.56}Mn_{0.25}CO_{0.15}Al_{0.03}O₂, the particles obtained by firing the mixture at 800° C. for 12 hours were ground to powders so that the specific surface area was adjusted to 2.1 m²/g, and the tap density of powdered composite oxide was 2.1 g/ml. This example is referred to as Test Cell R.

### Embodiment 12

In this example of preparing a composite oxide powder as a positive active material, preparation procedures were identical to those of Embodiment 1, except that the nominal composition was represented by LiNi_{0.56}Mn_{0.25}Co_{0.15}Al_{0.03}O₂, the particles obtained by firing the mixture at 800° C. for 12 hours were ground to powders so that the specific surface area was adjusted to 1.2 m²/g, and the tap density of powdered composite oxide was 2.5 g/ml. This example is referred to as Test Cell S.

### Embodiment 13

In this example of preparing a composite oxide powder as a positive active material, preparation procedures were identical to those of Embodiment 1, except that the nominal composition was represented by LiNi_{0.56}Mn_{0.25}Co_{0.15}Al_{0.03}O₂, the particles obtained by firing the mixture at 800° C. for 12 hours were ground to powders so that the specific surface area was adjusted to 0.5 m²/g, and the tap density of powdered composite oxide was 2.8 g/ml. This example is referred to as Test Cell T.

With Test Cells R to T in Embodiments 11 to 13, discharge capacities at 1.0 mA/cm² and 10.0 mA/cm², respectively, and discharge capacity retention after 50 charge and discharge cycles were measured, under the same condition as Embodiment 1. The obtained results are listed in Table 4.

TABLE 4

| | | Specific | | Discharge capacity | | |
|---|---|---|---|---|---|---|
| | | surface | Tap | (mAh/g) | | Discharge |
| | Test | area | density | 1.0 | 10.0 | capacity |
| | Cell | m²/g | g/ml | mA/cm² | A/cm² | retention % |
| Embod. | R | 2.1 | 2.1 | 182 | 130 | 94 |
| 11 | | | | | | |
| Embod. | S | 1.2 | 2.5 | 181 | 125 | 92 |
| 12 | | | | | | |
| Embod. | T | 0.5 | 2.8 | 180 | 126 | 96 |
| 13 | | | | | | |

Table 4 shows that when composite oxides having the nominal compositions which lie in the ranges specified in the present invention are used as positive active materials, in spite of changes in a specific surface area, both high-rate discharge performance and cycle performance can be achieved satisfactorily.

The foregoing test results revealed the following: in a powder which has a hexagonal crystal structure and is used as a positive active material, and wherein the nominal composition of said positive active material is represented by LiₐNi_{b}Co_{c}Mn_{d}AlₑO₂; the values of a, b, c, d, and e in said nominal equation fall within the ranges of 0.05≦a≦1.20, 0.25≦b≦0.93, 0.05≦c≦0.35, 0.01≦d≦0.35, 0.01≦e≦0.15, and 0.9≦b+c+d+e≦1.1, respectively; and the tap density of said powder lies 1.6 to 3.0 g/ml, a reduction in discharge capacity due to repeated charge and discharge can be prevented, and a high capacity can be obtained during discharge at either high or low rate. Therefore, in a non-aqueous electrolyte rechargeable battery which is manufactured and equipped with such a powder as a positive active material, it is obvious that a reduction in discharge capacity due to repeated charge and discharge can be prevented, and a high capacity can be obtained during discharge at either high or low rate.

With TAP DENSER KYT-3000 by Seishin Enterprise Co., Ltd., the measurement of the tap density of composite oxides was carried out as follows: put a sample into a 100 ml cylinder for tap density measurement, measure the weight of the sample, tap it 330 times, and calculate the tap density with use of the volume and sample weight after tapping. The tap density provides an indication of the density of particles, or how dense the particles are filled.

In the present invention, as a negative electrode material for a non-aqueous electrolyte rechargeable battery, various carbonaceous materials which can occlude/release lithium ion, or metal lithium or lithium alloy can be used. In addition, it is possible to use transition metal oxide or nitride.

Moreover, as a separator for a non-aqueous electrolyte rechargeable battery in the present invention, microporous membrane consisting of polyolefin resin such as polyethylene can be used. It is also possible to use materials prepared by laminating several microporous membranes each of which is different in material, weight-average molecular weight, or porosity, or materials prepared by adding various kinds of additives such as a plasticizer, an antioxidant, or a fire retardant in proper quantity.

On the organic solvent in the electrolyte solution used for a non-aqueous electrolyte rechargeable battery in the present invention, there is no special restriction. For example, it is possible to use ethers, ketones, lactones, nitriles, amines, amides, sulfur compounds, halogenated hydrocarbons, esters, carbonates, nitro compounds, phosphoric ester compounds, and sulfolane hydrocarbons. Among them, ethers, ketones, esters, lactones, halogenated hydrocarbons, carbonates, and suffolane compounds are preferable.

As specific examples of such organic solvents, the following and their mixed solvents can be listed: tetrahydrofuran, 2-methyltetrahydrofuran, 1,4-dioxane, anisole, monoglyme, 4-methyl-2-pentanone, ethyl acetate, methyl acetate, methyl propionate, ethyl propionate, 1,2-dichloroethane, γ-butyrolactone, dimethoxyethane, methyl formate, dimethyl carbonate, methyl ethyl carbonate, diethyl carbonate, propylene carbonate, ethylene carbonate, vinylene carbonate, dimethyl formamide, dimethyl sulphoxide, dimethyl thioformamide, sulfolane, 3-methyl-sulfolane, trimethyl phosphate, and triethyl phosphate. Among them, cyclic carbonates and cyclic esters are preferable. Furthermore, the most preferable organic solvents are one or the mixture of the following; ethylene carbonate, propylene carbonate, methyl ethyl carbonate, and diethyl carbonate.

On the electrolyte salt used for a non-aqueous electrolyte rechargeable battery in the present invention, there is no special restriction. LiClO₄, LiBF₄, LiAsF₆, CF₃SO₃Li, LiPF₆, LiPF₃(C₂F₅)₃, LiN(CF₃SO₂)₂, LiN(C₂F₅SO₂)₂, LiI, LiAlCl₄, or their mixtures can be used. Among them, LiBF₄, LiPF₆, and their mixtures are especially preferable.

By dissolving the foregoing electrolyte salts in the foregoing organic solvents, liquid electrolytes can be prepared.

Furthermore, as the foregoing electrolytes, it is possible to use solid ion conductive polymer electrolytes secondarily. In this case, a non-aqueous electrolyte rechargeable battery is comprised of a positive electrode, a negative electrode, and the combination of a separator, an organic or inorganic solid electrolyte, and the foregoing non-aqueous electrolyte solution; or a positive electrode, a negative electrode, and the combination of an organic or inorganic solid electrolyte membrane, as a separator, and the foregoing non-aqueous electrolyte solution. In case that the main component of a polymer electrolyte membrane is poly(ethylene oxide), polyacrylonitrile or poly(ethylene glycol), or the metamorphosis of these components, the polymer electrolyte membrane is light and flexible, so that it is advantageous to use it for a wound type electrode plate. Furthermore, in addition to the polymer electrolytes, it is possible to use an inorganic solid electrolyte or the mixed material of an organic polymer electrolyte and an inorganic solid electrolyte.

As for other battery components, there are collectors, terminals, insulating plates, a battery case, and so on. These parts may be used in a conventional manner.

It is obvious, as described above, that the present invention provides an excellent non-aqueous electrolyte rechargeable battery which has a high energy density and a long life. In addition, in the positive active materials used in the present invention, the content of expensive cobalt is less than that of the compound lithium cobalt oxide which is widely used these days. Thus, considering the resulting cost reduction, its industrial value is extremely useful.

This application is based on the patent which was filed on May 6, 2003 under Japanese Patent Application No. 128235 of 2003. According to this statement, all the contents in the description in Japanese Patent Application No. 128235 of 2003 may be inserted in this description as cited references.

1. A powder which has a hexagonal crystal structure and is used as a positive active material for a non-aqueous electrolyte rechargeable battery, and wherein
the nominal composition of said positive active material is represented by LiₐNi_{b}Co_{c}Mn_{d}AlₑO₂,
the values of a, b, c, d, and e in said nominal equation fall within the ranges of 0.05≦a≦1.20, 0.25≦b≦0.93, 0.05≦c≦0.35, 0.01≦d≦0.35, 0.01≦e≦0.15, and 0.9≦b+c+d+e≦1.1, respectively, and
the tap density of said powder lies 1.6 to 3.0 g/ml.

2. A non-aqueous electrolyte rechargeable battery comprising the powder according to claim 1 as a positive active material.

3. A method for manufacturing a non-aqueous electrolyte rechargeable battery which is characterized in using the powder according to claim 1 as a positive active material.
